(19) United States
(12) Patent Application Publication
(10) Pub. No.: US 2004/0080949 A1
(43) Pub. Date: Apr. 29, 2004

(54) Novel laminated retroreflective sheet & light-actuated trigerring equipment comprising the same

(76) Inventors: Moshe Klotz, London (GB); Hagai Sigalov, London (GB)

Correspondence Address: BIRCH STEWART KOLASCH & BIRCH, PO BOX 747, FALLS CHURCH, VA, 22040-0747, US

(21) Appl. No.: 10/257,315

(22) PCT Filed: Apr. 10, 2001
(86) PCT No.: PCT/GB01/01808

(30) Foreign Application Priority Data
Apr. 11, 2000 (GB) 0008920.1

(51) Int. Cl. F21V 7/00

(52) U.S. Cl. 362/341

(57) ABSTRACT

A laminated retroreflective sheet comprising a retroreflective layer having first and second mutually opposite major surfaces, wherein the first surface is retroreflective to light incident thereon and is treated to bear a predetermined design consisting of graphics and/or text: and adhesive or gripping layer contiguous the second surface of the retroreflective layer; and a transparent protective layer contiguous the first surface of the retrorefletive layer.

The present invention relates to a laminated retroreflective sheet for use with light-actuated triggering equipment. The present invention includes light-actuated triggering equipment comprising a laminated retroreflective sheet in accordance with the invention.

Floor messaging is widely used for displaying printed materials on a floor. For example, floor advertising is used as an advertising medium in supermarkets, grocers' stores and other locations. Floor messaging is also used for displaying information, such as directions, to the public, for example in museums, malls and leisure centres. Such floor messaging generally has a thin sheet of printed material that comprises a backing-layer of adhesive for adhering the sheet to a floor surface and a laminated, tough wearing, covering layer for protecting the sheet in use. The sheet is typically printed with eye-catching material and is attached to a floor in a prominent position of a supermarket or other location such that it will be noticed by people walking over or nearby the sheet.

U.S. Pat. No. 5,017,770 and GB-B-2183889 (Sigalov) disclose interactive light-to-MIDI equipment comprising a light source adapted to generate a beam of visible light, a light-sensing detector positioned adjacent to the light source within the beam and a retroreflector that is adapted to be positioned within the beam remote from the light source. In operation, light emitted by the light source is normally reflected back along its optical axis to the light source by the retroreflector to impinge upon the light-sensing detector. In the event that the beam of light is blocked, for example by a musician placing part of his or her body in the beam, then light from the light source is not returned to the light-sensing detector, resulting in a qualitative change in the output of the light-sensing detector. Such a change in the output of the light-sensing detector can be used to trigger operation of another device, and for practical purposes the output of the light-sensing detector is connected to a pulse generator for generating a pulse trigger signal when the beam of light between the light source and the retroreflector is obstructed. Said pulse generator may be adapted to produce an analogue or digital output pulse signal, and U.S. Pat. No. 5,017,770 and GB-B-2183889 particularly disclose that the trigger signal can be used for controlling a MIDI device such, for example, as a sound module.

An object of the present invention is to provide an enhanced messaging medium comprising a printed sheet that is adapted to be fastened to or immobilized on a surface, particularly a floor surface, e.g. floor advertising.

Another object of the present invention is to provide a multimedia messaging medium which combines visual printed material with other media associated with the printed material.

In particular, it is an object of the present invention to provide multimedia equipment for displaying printed messaging material on a suitable surface, particularly a floor surface, and triggering other media material associated with the printed material.

Yet another object of the present invention is to provide a printed sheet for displaying a predetermined design, particularly advertising material, which can be used in multimedia messaging equipment of the kind mentioned above.

The present invention thus provides a sheet which can be attached or substantially immobilised on a suitable surface for displaying printed matter, such, for example, as advertising copy or navigational directions. The sheet of the invention incorporates a retroreflective layer that is adapted to reflect light incident thereon back along its optical axis. The sheet of the invention can thus be used in conjunction with a light source and associated light-sensing detector for generating a pulse trigger signal when a beam of light generated by the light source and directed onto the sheet of the invention is interrupted.

The laminated retroreflective sheet in accordance with the invention may be adapted to be positioned on any suitable surface for prominent display. In particular, the sheet may be adapted for location on a ceiling, wall or floor surface, a counter top (for example in a bar), a shelf or on banisters. Preferably the sheet is flexible to allow the sheet to conform to the contours of said surface which may be curved or flat. Where the sheet of the invention is to be used on a floor surface, it is important that the sheet should be sufficiently thin not to constitute a trip-hazard. In this respect, the laminated retroreflective sheet in accordance with the invention is not significantly thicker than existing floor messaging sheets. Clearly the sheet of the invention may have any desired shape, for example rectilinear or curvilinear. Where the sheet is to be used on a floor surface, rounded corners are desirable to prevent scuffing, but not essential.

Preferably, the different layers of the laminated retroreflective sheet are permanently laminated together to form an integral unit. Ideally, the lamination is water-proof, moisture-resistant and/or hard-wearing. The sheet may be used indoors or outdoors, and should thus preferably be water-proof to prevent rain damage, and in any case where the sheet is to be used on a floor surface such, for example, as the floor or a supermarket or grocers' shop or a pavement (side-walk) outdoors the lamination should be water-proof such that it is not damaged by liquids spilt on the floor.

Said protective layer should be transparent at least to light having a wavelength or range of wavelengths to which the sheet is retroreflective. Preferably, the retroreflective layer is capable retroreflecting visible light and/or infrared light, and the protective layer is correspondingly transparent to such wavelengths of light.

Said retroreflective layer may be printed with any predetermined graphics and/or text. In some embodiments, the retroreflective layer may carry advertising copy. The design can be applied to the retroreflective layer by any suitable means which do not substantially interfere with the retroreflective properties of that layer. In some embodiments, the predetermined design may be screen-printed onto to the retroreflective layer.

Said adhesive or gripping layer is adapted for fastening or substantially immobilising the sheet of the invention to a surface with the first major surface of the sheet facing outwardly so as to display the over-printed design. Where the sheet is to be used on a floor surface, said sheet may comprise a gripping layer of soft rubber-like material that is adapted to grip the floor surface so as to inhibit slippage of the sheet when the sheet is walked-on. The sheet may thus constitute or resemble a floor mat. Alternatively, the sheet may comprise an adhesive layer adapted for permanently or removably attaching the sheet to a surface. By “permanently” is meant that the sheet can only be removed after use by the use of a suitable solvent for dissolving or weakening the adhesive which will usually destroy the sheet. In locations where the sheet is likely to receive heavy wear, for example a supermarket, it may be desirable to attach the sheet permanently to the floor surface. By “removably” is meant that the adhesive is sufficiently strong to retain the sheet in position during normal use, but can be readily removed as and when required. Thus, the adhesive layer may be adapted to allow the sheet to be peeled-off the surface, and possibly reapplied elsewhere, when required.

Where the retroreflective sheet of the invention carries an adhesive layer, said adhesive layer may be protected prior to use by a backing layer or a release liner of the kind well known in the art.

In accordance with another aspect of the invention there is provided light-actuated triggering equipment comprising a laminated retroreflective sheet in accordance with the invention that is adapted to be attached or substantially immobilised on a suitable surface; means for generating a beam of light that can be retroreflected by said retroreflective sheet; light-sensing detecting means adapted to be positioned adjacent to the light source for detecting light from said light source that is retroreflected by the retroreflective sheet; and means for generating an output trigger signal in response to a qualitative change in the amount of light detected by said light-sensing detecting means.

In use, said retroreflective sheet in accordance with the present invention is attached or substantially immobilised on a suitable surface as described above, and the light generating means is positioned remote from said sheet. Thus, for example, said sheet maybe attached to a floor surface, and the light generating means maybe fixedly secured in a position generally spaced above the sheet. For instance, the light generating means maybe suspended from a ceiling or fastened to an adjacent wall. Said light-generating means is arranged to direct a beam of light onto the retroreflective sheet such that the beam is retroreflected by the sheet back along its optical axis towards the light generating means. Said light-sensing detecting means is positioned adjacent to the light generating means in the retroreflected beam to detect said retroreflected beam. When the beam of light between the light generating means and said retroreflective sheet is obstructed, for example by a person walking over or adjacent the sheet, retroreflected light fails to reach the light-sensing means, resulting in a qualitative change in the amount of retroreflected light detected by the light-sensing means. The change in output of the light-sensing detecting means may be used to trigger another device. Preferably, the output of the light-sensing detecting means is connected to a pulse generator for generating a pulse trigger signal in response to such a qualitative change in the amount of retroreflected light detected by the light-sensing detecting means. Said pulse generating means may be adapted to generate a digital or analogue output pulse trigger signal as desired.

Said light generating means may be adapted to generate a beam of visible or infra-red light. In some applications, it may be desirable to make the beam of light inconspicuous, such that infra-red light is suitable.

Preferably, the light generating means and light-sensing detecting means may be incorporated in an integral unit. Said light-sensing detector may comprise a photosensitive element positioned within the beam of light generated by the light-generating means. Said unit may comprise light shielding means for shielding the photosensitive element from direct light from the light source and ambient light.

The trigger signal generated by the equipment in the present invention may be adapted to trigger any desired triggerable device for generating media associated with the design carried by the retroreflective sheet. Said triggerable device may comprise one or more of light-generating devices, video projection devices, colour-producing devices, pyrotechnics-producing devices and audio devices. In a particularly preferred embodiment, the trigger signal may be adapted to trigger an audio device for generating an audio signal associated with the printed visual material on the sheet. For example, the retroreflective sheet may be printed with visual material and the audio device may be adapted to generate a short audio signal consisting of speech and/or music and/or sound effects associated with the printed material. Said audio device may comprise a sound module adapted to synthesise an audio signal in response to an input trigger pulse signal from the light-sensing detecting means or a playback device adapted to reproduce a pre-recorded or sampled audio signal when triggered.

In another aspect of the present invention, the light-actuated triggering equipment of the invention may incorporate an audio or other multimedia device of the kind described above.

Following is a description by way of example only with reference to the accompanying drawings of embodiments of the present invention.

In the drawings:

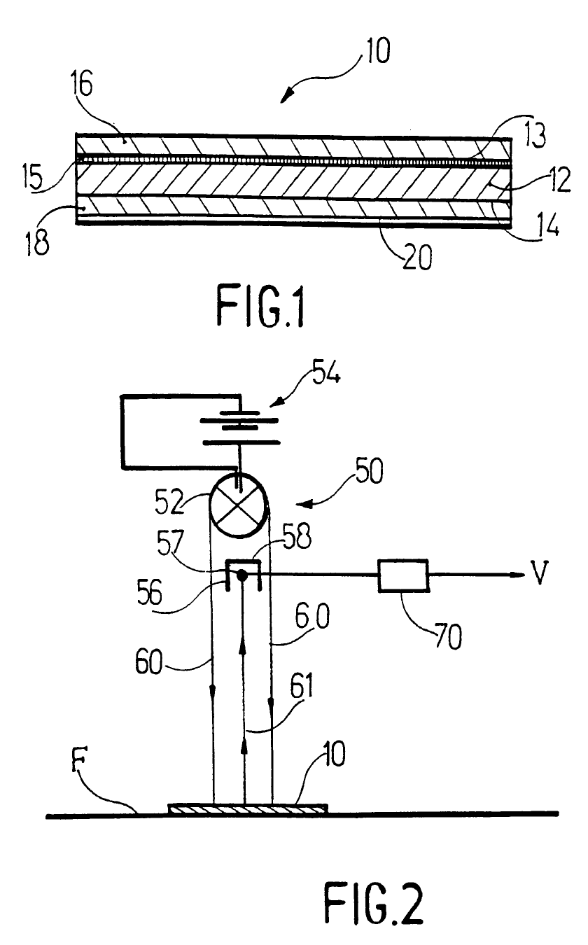

FIG. 1 is a schematic cross-sectional side view of a laminated retroreflective sheet in accordance with the present invention.

FIG. 2 is a diagram of light-actuated triggering equipment in accordance with the present invention incorporating a retroreflective sheet.

With reference to FIG. 1, a laminated retroreflective sheet generally indicated by reference numeral 10 comprises a retroreflective layer 12 having a first major surface 13 and a second major surface 14 that is opposite to said first surface. Said first surface 13 is screen printed as shown at 15 with predetermined printed material such, for example, as advertising copy consisting of graphics and/or text. Said first printed surface 13 is completely covered by a transparent protective layer 16 that is laminated to the retroreflective layer 12.

Said retroreflective layer 12 may comprise any suitable retroreflective plastics material that is capable of being over-printed. Any suitable form of printing may be used, but screen-printing may be particularly mentioned.

The protective transparent layer 16 comprises a wear-resistant, water-proof layer of transparent plastics material that is compatible with the retroreflective layer, such that the two layers can be laminated together without impairing the printed material on the first surface 13 of the retroreflective layer 12. Said protective layer 16 may comprise a layer of hot-melt adhesive for enabling the protective layer 16 to be laminated to the retroreflective layer 12 by the application of heat and pressure in the usual way. Said hot melt adhesive is adapted to form a resilient, water-proof bond between the protective layer 16 and the retroreflective layer 12. Of course, those skilled in the art will appreciate that numerous other possibilities exist for laminating the protective layer to the retroreflective layer by hot or cold processes.

Said second surface 14 of the retroreflective layer 12 is coated with a layer of tacky adhesive 18 for attaching the sheet 10 to a surface. Said adhesive layer 18 is covered by a continuous release liner 20 for protecting the adhesive layer 18 prior to use.

In some embodiments, the adhesive layer 18 may be adapted to provide a releasable bond to a surface such that the sheet 10 can be readily peeled from the surface and optionally reapplied subsequently to a surface at the same or different location. Preferably, however the adhesive comprises a permanent adhesive adapted to form a strong, permanent, wear-resistant and water-proof bond to the surface. That is particularly desirable where the sheet 10 is desired to be attached to a floor surface in an area subject to heavy usage.

In FIG. 1, the thickness of the laminated sheet 10 is greatly exaggerated, and in reality, the sheet is sufficiently thin that when applied to a floor surface it does not constitute a significant trip-hazard. Furthermore, the sheet 10 is flexible to allow the sheet to conform to the contours of the surface to which the sheet is fastened so that the sheet can be attached to curved surfaces as well as flat surfaces.

FIG. 2 shows diagrammatically light-actuated triggering equipment in accordance with the invention comprising a laminated retroreflective sheet 10 of the kind described above which can be fastened to a floor surface F by means of the adhesive layer 18 as shown in FIG. 1. Said equipment further comprises a light unit 50 comprising a source of infra-red light 52 connected to a suitable power supply indicated schematically at 54 and a light sensing detector 56. Said light unit 50 is provided with suitable fixings (not shown) for fixing the light unit 50 to a suitable attachment remote from the sheet 10. In some embodiments, the light unit 50 may be suspended from a ceiling above the sheet 10, such that the light 50 is positioned above head-height. Said light source 52 is arranged to direct a beam of light (e.g. visible and infra-red light) indicated by rays 60 in FIG. 2 onto the retroreflective sheet 10. Said light detector 56 is positioned within the beam in front of the light source 52 and comprises a photosensitive element 57 and a shield 58 that shields the photosensitive element 57 from direct light emitted by the light source and from ambient light. Said light sensitive element 57 is connected to a pulse generator 70 that is adapted to generate a digital or analogue output pulse trigger signal in response to a qualitative fall in the intensity of light detected by the photosensitive element 57. In operation, light 60 emitted by the light source 52 falls incident on the retroreflective sheet 10 and is reflected back along its original axis indicated by ray 61 in FIG. 2 towards the light unit 50 where it falls incident on the photosensitive 57 element of the light detector 56. In the event that the beam of light 60,61 between the light unit 50 and the sheet 10 is obstructed, the intensity of light detected by the light sensitive element 57 drops qualitatively, thus causing the pulse generator 70 to generate an output trigger pulse which can be used to trigger an external triggerable audio device (not shown).

The light-actuated equipment may be installed in a supermarket or any other public space with the sheet 10 attached to the floor (as shown in FIG. 2), and the light unit 50 installed above head-height. The retroreflective sheet 10 is screen-printed with predetermined printed messaging material, and the pulse generator 70 is connected to a multimedia device such, for example, as (e.g. a sound module or a playback device) adapted to generate an audio signal that corresponds to the printed material on the sheet 10. Thus, when a person walks over or adjacent the sheet 10 through the beam 60, 61, the beam is interrupted, thus triggering the audio device to produce the audio signal, which may, for example, be an advertising jingle, voice-over or sound-effect associated with advertising copy on the printed sheet 10.

The combined visual and audio stimuli offered by the equipment of the present invention can be used by advertisers or other users to provide an enhanced multimedia messaging medium which represents a significant advance over the purely printed floor messaging that has been used hitherto. In particular, the automatic generation of audio in response to a consumer's movement on or adjacent a sheet of printed material applied to a surface, particularly, but not exclusively a floor surface, will draw the consumer's attention more definitely to the printed material, and by intriguing the consumer as to the origin of the audio signal may even cause the consumer to linger in the presence of the printed sheet and to register the presence of the sheet and the associated sound more positively. As mentioned above, in addition to, or as an alternative to a triggerative audio device, the triggering equipment of the present invention may be used to trigger any desired multimedia associated with the printed material on the sheet, for example light, video, smell and pyrotechnics.

1. A laminated retroreflective sheet comprising a retroreflective layer having a first and second mutually opposite major surfaces, wherein the first surface is retroreflective to light incident thereon and is treated to bear a predetermined design consisting of graphics and/or text; an adhesive or gripping layer contiguous the second surface of the retroreflective layer; and a transparent protective layer contiguous of the first surface of the retroreflective layer.

2. A laminated retroreflective sheet as claimed in claim 1, wherein said sheet is flexible to allow the sheet to conform to the contours of a surface to which the sheet is to be attached.

3. A laminated retroreflective sheet as claimed in claim 1 or claim 2, having rounded corners.

4. A laminated retroreflective sheet as claimed in claim 1, claim 2 or claim 3, where the different layers are permanently laminated together to form an integral unit.

5. A laminated retroreflective sheet as claimed in any preceding claim wherein the lamination is waterproof, moisture resistant and/or hard wearing.

6. A laminated retroreflective sheet as claimed in any preceding claim wherein said protective layer is transparent at least to light having a wavelength or range of wavelengths to which the sheet is retroreflective.

7. A laminated retroreflective sheet as claimed in any preceding claim wherein the retroreflective layer is capable of retroreflecting visible light and/or infra-red light and said protective layer is correspondingly transparent to such wavelengths of light.

8. A laminated retroreflective sheet as claimed in any preceding claim wherein the retroreflective layer is printed with predetermined graphics and/or text.

9. A laminated retroreflective sheet as claimed in claim 8, wherein the predetermined design is screen-printed onto the retroreflective layer.

10. A laminated retroreflective sheet as claimed in any preceding claim wherein said adhesive or gripping layer is adapted for fastening or substantially immobilising the sheet on a surface with the major first surface of the sheet facing outwardly so as to display the over printed design.

11. A laminated retroreflective sheet as claimed in any preceding claim, wherein the sheet comprises a gripping layer of soft rubber-like material that is adapted to grip a floor surface so as to inhibit slippage of the sheet when the sheet is walked on.

12. A laminated retroreflective sheet as claimed in any of claims 1 to 10, wherein the sheet comprises an adhesive layer adapted for permanently or removably attaching the sheet to a surface.

13. Light-actuated triggering equipment comprising a laminated retroreflective sheet as claimed in any of claims 1 to 12 that is adapted to be attached or substantially immobilised on a suitable surface; means for generating a beam of light that can be retroreflected by said retroreflective sheet; light sensing detecting means adapted to be positioned adjacent to the light source for detecting light from said light source that is retroreflected by the retroreflective sheet; and means for generating an output trigger signal in the response to a qualitative change in the amount of light detected by said light sensing detecting means.

14. Light-actuated triggering equipment as claimed in claim 13, wherein said light-generating means is arranged to direct a beam of light onto the retroreflective sheet such that the beam is retroreflected sheet back along its optical axis towards the light generating means.

15. Light-actuated triggering equipment as claimed in claim 13 or 14, wherein said light sensing detecting means is positioned adjacent to the light generating means in the retroreflected beam to detect said retroreflected beam.

16. Light-actuated triggering equipment as claimed in any of claims 13 to 15, wherein the output of the light-sensing detecting means is connected to pulse generator for generating a pulse trigger signal in response to a qualitative change in the amount of retroreflected light detected by the light sensing detecting means.

17. Light-actuated triggering equipment as claimed in any of claims 13 to 16, wherein said light generating means is adapted to generate invisible or infra-red light.

18. Light-actuated triggering equipment as claimed in any of claims 13 to 17, wherein the light generating means and light-sensing detecting means are incorporated in an integral unit.

19. Light-actuated triggering equipment as claimed in any of claims 13 to 18, wherein the trigger signal generated by the equipment is adapted to trigger any desired triggerable device for generating media associated with the design carried by the retroreflective sheet.

20. Light-actuated triggering equipment as claimed in any of claims 13 to 18, further comprising an audio or other multimedia device adapted to be triggered by said output trigger signal.
